(19) United States
(12) Patent Application Publication
(10) Pub. No.: US 2013/0284054 A1
(43) Pub. Date: Oct. 31, 2013

(54) RAPID SOLIDIFYING CRYSTALLINE-AMORPHOUS INKS

(71) Applicants: Gabriel Iftime, Mississauga Ontario (CA); Jennifer L. Belelie, Oakville (CA); Daryl W. Vanbesien, Burlington (CA); Peter G. Odell, Mississauga (CA); Kentaro Morimitsu, Mississauga (CA); Naveen Chopra, Oakville (CA)

(72) Inventors: Gabriel Iftime, Mississauga Ontario (CA); Jennifer L. Belelie, Oakville (CA); Daryl W. Vanbesien, Burlington (CA); Peter G. Odell, Mississauga (CA); Kentaro Morimitsu, Mississauga (CA); Naveen Chopra, Oakville (CA)

(73) Assignee: XEROX CORPORATION, Norwalk, CT (US)

(21) Appl. No.: 13/457,271

(22) Filed: Apr. 26, 2012

(51) Int. Cl. C09D 11/00

(52) U.S. Cl. 106/31.27; 106/31.13; 106/31.6

(57) ABSTRACT

A phase change ink composition comprising an amorphous compound and a crystalline compound capable of crystallizing at a total crystallization time of less than 15 seconds and methods of making the same.

### CROSS-REFERENCE TO RELATED APPLICATIONS

Reference is made to commonly owned and co-pending, U.S. patent application Ser. No. ______ (not yet assigned) entitled “Phase Change Ink Compositions Comprising Crystalline Diurethanes And Derivatives Thereof” to Naveen Chopra et al., electronically filed on the same day herewith (Attorney Docket No. 20110356-396152); U.S. patent application Ser. No. ______ (not yet assigned) entitled “Phase Change Ink Compositions Comprising Crystalline Sulfone Compounds and Derivatives Thereof” to Kentaro Morimitsu et al., electronically filed on the same day herewith (Attorney Docket No. 20110561-396955); U.S. patent application Ser. No. ______ (not yet assigned) entitled “Phase Change Inks Comprising Crystalline Amides” to Kentaro Morimitsu et al., electronically filed on the same day herewith (Attorney Docket No. 20110665-397243); U.S. patent application Ser. No. ______ (not yet assigned) entitled “Phase Change Ink Compositions Comprising Aromatic Ethers” to Kentaro Morimitsu et al., electronically filed on the same day herewith (Attorney Docket No. 20110362-396157); U.S. patent application Ser. No. ______ (not yet assigned) entitled “Fast Crystallizing Crystalline-Amorphous Ink Compositions And Methods For Making The Same” to Gabriel Iftime et al., electronically filed on the same day herewith (Attorney Docket No. 20110459-399389);U.S. patent application Ser. No. ______ (not yet assigned) entitled “Phase Change Inks Comprising Inorganic Nucleating Agents” to Daryl W. Vanbesien et al., electronically filed on the same day herewith (Attorney Docket No. 20111206-400896); U.S. patent application Ser. No. ______ (not yet assigned) entitled “Phase Change Inks Comprising Fatty Acids” to Gabriel Iftime et al., electronically filed on the same day herewith (Attorney Docket No. 20110815-399390); U.S. patent application Ser. No. ______ (not yet assigned) entitled “Phase Change Inks Comprising Aromatic Diester Crystalline Compounds” to Kentaro Morimitsu et al., electronically filed on the same day herewith (Attorney Docket No. 20111040-399927); U.S. patent application Ser. No. ______ (not yet assigned) entitled “Phase Change Ink Compositions Comprising Diurethanes as Amorphous Materials” to Naveen Chopra et al., electronically filed on the same day herewith (Attorney Docket No. 20110610-397242); U.S. patent application Ser. No. ______ (not yet assigned) entitled “Phase Change Inks Comprising Organic Pigments” to Jennifer Belelie et al., electronically filed on the same day herewith (Attorney Docket No. 20110418-399388); and U.S. patent application Ser. No. ______ (not yet assigned) entitled “TROM Process for Measuring the Rate of Crystallization of Phase Change Inks” to Gabriel Iftime et al., electronically filed on the same day herewith (Attorney Docket No. 20110828-401275), U.S. patent application Ser. No. ______ (not yet assigned) entitled “Rapidly Crystallizing Phase Change Inks and Methods for Forming the Same” to Jennifer Belelie et al., electronically filed on the same day herewith (Attorney Docket No. 20111455-403044); the entire disclosures of which are incorporated herein by reference in its entirety.

### BACKGROUND

The present embodiments relate to phase change ink compositions characterized by being solid at room temperature (e.g., 20-27° C.) and molten at an elevated temperature at which the molten ink is applied to a substrate. These phase change ink compositions can be used for ink jet printing. The present embodiments are directed to a novel phase change ink composition comprising an amorphous material, a crystalline material, and optionally a colorant, and methods of making the same.

Ink jet printing processes may employ inks that are solid at room temperature and liquid at elevated temperatures. Such inks may be referred to as solid inks, hot melt inks, phase change inks and the like. For example, U.S. Pat. No. 4,490,731, the disclosure of which is totally incorporated herein by reference, discloses an apparatus for dispensing phase change ink for printing on a recording medium such as paper. In piezo ink jet printing processes employing hot melt inks, the phase change ink is melted by the heater in the printing apparatus and utilized (jetted) as a liquid in a manner similar to that of conventional piezo ink jet printing. Upon contact with the printing recording medium, the molten ink solidifies rapidly, enabling the colorant to substantially remain on the surface of the recording medium instead of being carried into the recording medium (for example, paper) by capillary action, thereby enabling higher print density than is generally obtained with liquid inks. Advantages of a phase change ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

In general, phase change inks (sometimes referred to as “hot melt inks”) are in the solid phase at ambient temperature, but exist in the liquid phase at the elevated operating temperature of an ink jet printing device. At the jetting temperature, droplets of liquid ink are ejected from the printing device and, when the ink droplets contact the surface of the recording medium, either directly or via an intermediate heated transfer belt or drum, they quickly solidify to form a predetermined pattern of solidified ink drops.

Phase change inks for color printing typically comprise a phase change ink carrier composition which is combined with a phase change ink compatible colorant. In a specific embodiment, a series of colored phase change inks can be formed by combining ink carrier compositions with compatible subtractive primary colorants. The subtractive primary colored phase change inks can comprise four component dyes or pigments, namely, cyan, magenta, yellow and black, although the inks are not limited to these four colors. These subtractive primary colored inks can be formed by using a single dye or pigment or a mixture of dyes or pigments. For example, magenta can be obtained by using a mixture of Solvent Red Dyes or a composite black can be obtained by mixing several dyes. U.S. Pat. No. 4,889,560, U.S. Pat. No. 4,889,761, and U.S. Pat. No. 5,372,852, the disclosures of each of which are totally incorporated herein by reference, teach that the subtractive primary colorants employed can comprise dyes from the classes of Color Index (C.I.) Solvent Dyes, Disperse Dyes, modified Acid and Direct Dyes, and Basic Dyes. The colorants can also include pigments, as disclosed in, for example, U.S. Pat. No. 5,221,335, the disclosure of which is totally incorporated herein by reference. U.S. Pat. No. 5,621,022, the disclosure of which is totally incorporated herein by reference, discloses the use of a specific class of polymeric dyes in phase change ink compositions.

Phase change inks are desirable for ink jet printers because they remain in a solid phase at room temperature during shipping, long term storage, and the like. In addition, the problems associated with nozzle clogging as a result of ink evaporation with liquid ink jet inks are largely eliminated, thereby improving the reliability of the ink jet printing. Further, in phase change ink jet printers wherein the ink droplets are applied directly onto the final recording medium (for example, paper, transparency material, and the like), the droplets solidify immediately upon contact with the recording medium, so that migration of ink along the printing medium is prevented and dot quality is improved.

While the above conventional phase change ink technology is successful in producing vivid images and providing economy of jet use and substrate latitude on porous papers, such technology has not been satisfactory for coated substrates. Thus, while known compositions and processes are suitable for their intended purposes, a need remains for additional means for forming images or printing on coated paper substrates. As such, there is a need to find alternative compositions for phase change ink compositions and future printing technologies to provide customers with excellent image quality on all substrates, including selecting and identifying different classes of materials that are suitable for use as desirable ink components. There is a further need for printing these inks at high speeds as required by digital presses in production environment.

Each of the foregoing U.S. patents and patent publications are incorporated by reference herein. Further, the appropriate components and process aspects of the each of the foregoing U.S. patents and patent publications may be selected for the present disclosure in embodiments thereof.

There is further a need to provide such phase change ink compositions which are suitable for fast printing environments like production printing.

### SUMMARY

According to embodiments illustrated herein, there is provided novel phase change ink compositions comprising an amorphous and, a crystalline material which are suitable for ink jet high speed printing, including printing on coated paper substrates. In particular, these phase change ink are capable of crystallizing at a total crystallization time of less than 15 seconds.

In particular, the present embodiments provide a phase change ink comprising an amorphous compound; and a crystalline compound; wherein the phase change ink is capable of crystallizing at a total crystallization time of less than 15 seconds.

In embodiments, there is provided a phase change ink comprising an amorphous compound; and a crystalline compound; a crystallization accelerating additive; wherein the phase change ink is capable of crystallizing at a total crystallization time of less than 15 seconds.

In further embodiments, there is provided a phase change ink comprising an amorphous compound; and a crystalline compound; wherein the phase change ink is capable of crystallizing at a total crystallization time of less than 15 seconds; wherein the amorphous compound comprises an amorphous core moiety having at least one functional group and being attached to at least one amorphous terminal group; the crystalline compound comprises a crystalline core moiety having at least one functional group and being attached to at least one crystalline terminal group; wherein no one functional group in the amorphous core moiety is the same as any of the functional group of the crystalline core moiety and wherein the amorphous terminal group comprises an alkyl, wherein the alkyl is straight, branched or cyclic, saturated or unsaturated, substituted or unsubstituted, having from about 1 to about 16 carbon atoms; and wherein the crystalline terminal group comprises an aromatic groups.

In yet other embodiments, there is provided a phase change ink comprising an amorphous comprises an ester of tartaric acid of Formula I or an ester of citric acid of Formula II

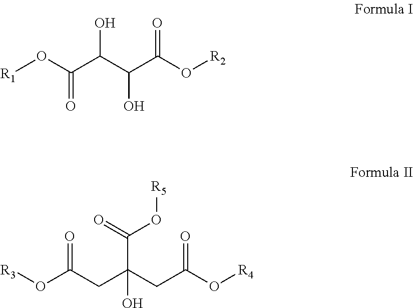

wherein each R₁, R₂, R₃, R₄ and R₅ is independently an alkyl group, wherein the alkyl can be straight, branched or cyclic, saturated or unsaturated, substituted or unsubstituted, having from about 1 to about 16 carbon atoms; a crystalline compound; and a colorant; wherein the phase change ink is capable of crystallizing at a total crystallization time of less than 15 seconds; wherein the crystalline/amorphous ratio is from about 60:40 to about 95:5.

### BRIEF DESCRIPTION OF THE DRAWINGS

For a better understanding of the present embodiments, reference may be had to the accompanying figures.

FIG. 1 illustrates the TROM process showing images of crystalline formation from crystallization onset to crystallization completion according to an embodiment of the disclosure.

### DETAILED DESCRIPTION

In the following description, it is understood that other embodiments may be utilized and structural and operational changes may be made without departure from the scope of the present embodiments disclosed herein.

Phase change ink technology broadens printing capability and customer base across many markets, and the diversity of printing applications will be facilitated by effective integration of printhead technology, print process and ink materials. The phase change ink compositions are characterized by being solid at room temperature and molten at an elevated temperature at which the molten ink is applied to a substrate. As discussed above, while current ink options are successful for porous paper substrates, these options are not always satisfactory for coated paper substrates.

It was previously discovered that using a mixture of crystalline and amorphous small molecule compounds in phase change ink formulations provides robust inks, and in particular, phase change inks which demonstrate robust images on coated paper. (U.S. patent application Ser. No. 13/095,636 entitled “Solid Ink Compositions Comprising Crystalline-Amorphous Mixtures” to Jennifer L. Belelie et. al., (Attorney Docket No. 20101286-390681) filed Apr. 27, 2011).

Print samples made with such phase change inks demonstrate better robustness with respect to scratch, fold, and fold offset as compared to currently available phase change inks.

Such robust inks may be used with printing equipment at high speeds. Typically, production digital presses print at a speed comprised from about 100 to 500 or more feet/minute. This requires inks which are capable of solidifying very fast once placed onto the paper, in order to prevent offset of the printed image during fast printing process, where printed paper is either stacked (cut-sheet printers) or rolled (continuous feed printers).

However, the present inventors discovered that in many cases mixtures made of crystalline and amorphous materials with optional dye colorant solidify slowly when printed on substrates from a molten state. Such slow solidifying inks are not suitable for high speed printing environments, like for example production printing, where printing at a speeds higher than 100 feet per minute is required. Solidification of the ink is due to crystallization of the crystalline component ink the ink when cooling.

The inventors have found that fast crystallization of a composition made of a crystalline and an amorphous component is not an inherent property of the composition.

In some cases, the crystallization process of a crystalline-amorphous ink is accelerated by careful selection of the pair of crystalline and amorphous component. For example a given crystalline component may be providing a fast crystallizing composition when mixed with one amorphous component but the same crystalline component can result in a slow crystallizing composition when mixed with a different amorphous component.

In other cases, a given crystalline-amorphous ink composition can be made to crystallize faster by adding suitable crystallization accelerators. As described before, fast crystallizing crystalline-amorphous ink compositions are not obvious and methods for providing fast crystallizing crystalline-amorphous inks are not disclosed in prior art.

In order to evaluate the suitability of a test ink for fast printing a quantitative method for measuring the rates of crystallization of phase change inks containing crystalline components was developed. TROM (Time-Resolved Optical Microscopy) enables comparison between various test samples and, as a result, is a useful tool for monitoring the progress made with respect to the design of fast crystallizing inks. TROM is described in co-pending U.S. patent application Ser. No. ______ (not yet assigned) entitled “TROM Process for Measuring the Rate of Crystallization of Solid Inks” to Gabriel Iftime et al., electronically filed on the same day herewith (Attorney Docket No. 20110828-401275).

Time Resolved Optical Microscopy TROM monitors the appearance and the growth of crystals by using Polarized Optical Microscopy (POM). The sample is placed between crossed polarizers of the microscope. Crystalline materials are visible because they are birefringent. Amorphous materials or liquids, similar to, for example, inks in their molten state that do not transmit light, appear black under POM. Thus, POM enables an image contrast when viewing crystalline components and allows for pursuing crystallization kinetics of crystalline-amorphous inks when cooled from the molten state to a set-temperature.

In order to obtain data that allow comparison between different and various samples, standardized TROM experimental conditions were set, with the goal of including as many parameters relevant to the actual printing process.

The key set parameters include:

(a) glass slides of a 16-25 mm diameter and a thickness comprise in between 0.2 mm to 0.5 mm.

(b) ink sample thickness comprised in a range from 5 to 25 microns

(c) cooling temperature set at 40° C.

For rate of crystallization measurement, the sample is heated to the expected jetting temperature (viscosity=10-12 cps) via an offline hotplate and then transferred to a cooling stage coupled with an optical microscope. The cooling stage is thermostated at a preset temperature which is maintained by controlled supply of heat and liquid nitrogen. This experimental set-up models the expected drum/paper temperature onto which a drop of ink would be jetted in real printing process (40° C. for the experiments reported in this disclosure). Crystal formation and growth is recorded with a camera.

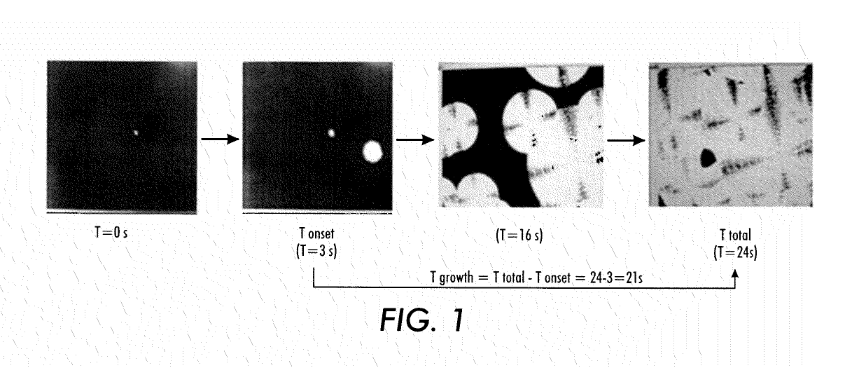

The key steps in the TROM process are illustrated in FIG. 1, highlighting the key steps in the measuring process with the mainline ink base which contains just amorphous and crystalline components (no dye or pigment). When viewed under POM, the molten and at time zero, the crystalline-amorphous inks appear black as no light is passed through. As the sample crystallizes, the crystalline areas appear brighter. The numbers reported by TROM include: the time from the first crystal (crystallization onset) to the last (crystallization completion).

The definition of key measured parameters of the TROM process are set forth below:
Time zero (T=0 s)—the molten sample is placed on the cooling stage under microscope
T onset=the time when the first crystal appears
T growth=the duration of the crystal growth from the first crystal (T onset) to the completion of the crystallization (T total)
T total=T onset+T growth

It should be understood that the crystallization times obtained with the TROM method for selected inks are not identical to what would be the crystallization times of a droplet of ink in an actual printing device. In an actual printing device such as a printer, the ink solidifies much faster. We determined that there is a good correlation between the total crystallization time as measured by the TROM method and the solidification time of an ink in a printer. In the standardized conditions described above, we determined that inks solidify within 10-15 seconds or less measured by the TROM method, are suitable for fast printing, typically at speeds from 100 feet/minute or higher. Therefore, for the purpose of the present disclosure, a rate of crystallization lower than 15 seconds is considered to be fast crystallizing.

In certain fast crystallizing crystalline-amorphous inks are provided by using a composition wherein the crystalline and amorphous components have limited compatibility. By limited compatibility it is understood that the two components have a tendency to quickly phase separate when cooled down from a molten state. Limited compatibility is achieved by selecting the crystalline and amorphous components such as to satisfy a set of design rules regarding the relationship between the functional groups present in the chemical structures of a selected pair of a crystalline and amorphous components respectively, to enable the ability to fast crystallize. (U.S. patent application Ser. No. ______ (not yet assigned) entitled “Fast Crystallizing Crystalline-Amorphous Ink Compositions and Methods for Making the Same” to Gabriel Iftime et al., electronically filed on the same day herewith (Attorney Docket No. 20110459-399389); The design rules are set forth below:

(1) The phase change ink composition comprises an amorphous compound and a crystalline compound;

(2) The amorphous compound comprises an amorphous core moiety having at least one functional group and being attached to at least one amorphous terminal group, wherein the amorphous terminal group comprises an alkyl group, wherein the alkyl is straight, branched or cyclic, saturated or unsaturated, substituted or unsubstituted, having from about 1 to about 16 carbon atoms; a diagram showing the structure of an amorphous compound is shown below:

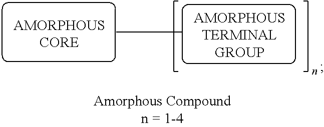

(3) The crystalline compound comprises a crystalline core moiety having at least one functional group and being attached to at least one crystalline terminal group, wherein the crystalline terminal group comprises an aromatic group; a diagram showing the structure of a crystalline compound is shown below:

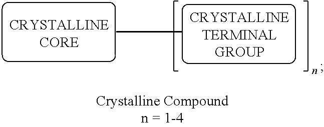

and

(4) No one functional group in the amorphous core moiety is the same as any of the functional group of the crystalline core moiety.

The Amorphous Compound

In embodiments, the amorphous compound may comprise an ester of tartaric acid of Formula I or an ester of citric acid of Formula II

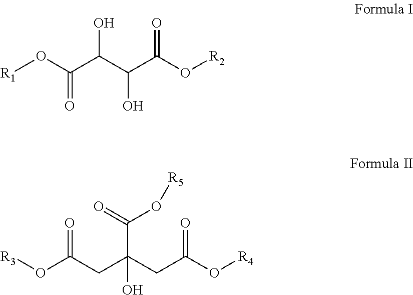

wherein each R₁, R₂, R₃, R₄, and R₅ is independently an alkyl group, wherein the alkyl can be straight, branched or cyclic, saturated or unsaturated, substituted or unsubstituted, having from about 1 to about 16 carbon atoms. In certain embodiments, each R₁, R₂, R₃, R₄ and R₅ is independently a cyclohexyl group optionally substituted with one or more alkyl groups. In certain of such embodiments, the alkyl groups is selected from methyl, ethyl, n-propyl, isopropyl, n-butyl and t-butyl. In certain embodiments, each R₁, R₂, R₃, R₄ and R₅ is independently a cyclohexyl group optionally substituted with one or more alkyl groups selected from methyl, ethyl, n-propyl, isopropyl, n-butyl and t-butyl.

Referring to Formula I, in certain embodiments, one of R₁ and R₂ is 2-isopropyl-5-methylcyclohexyl, and the other one of R₁ and R₂ is 2-isopropyl-5-methylcyclohexyl, 4-t-butylcyclohexyl, or cyclohexyl, or one of R₁ and R₂ is 4-t-butylcyclohexyl, and the other one of R₁ and R₂ is cyclohexyl. In certain embodiments, R₁ and R₂ are each 2-isopropyl-5-methylcyclohexyl. In certain embodiments, R₁ is 2-isopropyl-5-methylcyclohexyl and R₂ is 4-t-butylcyclohexyl. In certain embodiments, R₁ is 2-isopropyl-5-methylcyclohexyl and R₂ is cyclohexyl. In certain embodiments, R₁ is 4-t-butylcyclohexyl and R₂ is cyclohexyl.

Referring to Formula II, in certain embodiments, one of R₃,R₄ and R₅ is 2-isopropyl-5-methylcyclohexyl, and the other one of R₃, R₄ and R₅ is 2-isopropyl-5-methylcyclohexyl, 4-t-butylcyclohexyl, or cyclohexyl, or one of R₃, R₄ and R₅ is 4-t-butylcyclohexyl, and the other one of R₃, R₄ and R₅ is cyclohexyl. In certain embodiment, R₃, R₄ and R₅ are each 2-isopropyl-5-methylcyclohexyl. In certain embodiment, R₃ is 2-isopropyl-5-methylcyclohexyl and R₄ and R₅ are each 4-t-butylcyclohexyl. In certain embodiment, R₃ is 2-isopropyl-5-methylcyclohexyl and R₄ and R₅ are each cyclohexyl. In certain embodiment, R₁ is 4-t-butylcyclohexyl and R₄ and R₅ are each cyclohexyl

Some suitable amorphous materials are disclosed in U.S. patent application Ser. No. 13/095,784 to Morimitsu et al., which is hereby incorporated by reference in its entirety. The amorphous materials may comprise an ester of tartaric acid having a formula of

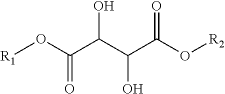

wherein R₁ and R₂ each, independently of the other or meaning that they can be the same or different, is selected from the group consisting of alkyl group, wherein the alkyl portion can be straight, branched or cyclic, saturated or unsaturated, substituted or unsubstituted, having from about 1 to about 16 carbon atoms. In certain embodiments, each R₁ and R₂ is independently a cyclohexyl group optionally substituted with one or more alkyl group(s) selected from methyl, ethyl, n-propyl, isopropyl, n-butyl and t-butyl.

The tartaric acid backbone is selected from L-(+)-tartaric acid, D-(−)-tartaric acid, DL-tartaric acid, or mesotartaric acid, and mixtures thereof. Depending on the R groups and the stereochemistries of tartaric acid, the esters could form crystals or stable amorphous compounds. In specific embodiments, the amorphous compound is selected from the group consisting of di-L-menthyl L-tartrate, di-DL-menthyl L-tartrate (DMT), di-L-menthyl DL-tartrate, di-DL-menthyl DL-tartrate, and any stereoisomers and mixtures thereof.

Mixtures of aliphatic alcohols may be used in the esterification. For example, a mixture of two aliphatic alcohols may be used in the esterification. Suitable examples of aliphatic alcohols that can be used in these mixed reactions are cyclohexanol and substituted cyclohexanols (e.g., 2-, 3- or 4-t-butyl cyclohexanol). The molar ratios of the aliphatic alcohols may be from 25:75 to 75:25, from 40:60 to 60:40, or about 50:50.

The amorphous compound may comprise an ester of citric acid disclosed in U.S. patent application Ser. No. 13/095,795 to Morimitsu et al., which is hereby incorporated by reference in its entirety. These amorphous materials are synthesized by an esterification reaction of citric acid. In particular, citric acid was reacted with a variety of alcohols to make tri-esters according to the synthesis scheme shown in U.S. patent application Ser. No. 13/095,795. The amorphous compounds are synthesized by an esterification reaction of tartaric acid.

These materials show relatively low viscosity (<10² centipoise (cps), or from about 1 to about 100 cps, or from about 5 to about 95 cps) near the jetting temperature (≦140° C., or from about 100 to about 140° C., or from about 105 to about 140° C.) but very high viscosity (>10⁵ cps) at room temperature. These characteristics make the materials good candidates for the amorphous component.

In particular, di-DL-menthyl L-tartrate (DMT) was found to be especially suitable for use as an amorphous compound in the present ink embodiments.

To synthesize the amorphous component, tartaric acid was reacted with a variety of alcohols to make di-esters as shown in the synthesis scheme shown in U.S. patent application Ser. No. 13/095,784. A variety of alcohols may be used in the esterification such as, for example, menthol, isomenthol, neomenthol, isoneomenthol, and any stereoisomers and mixtures thereof. Mixtures of aliphatic alcohols may be used in the esterification. For example, a mixture of two aliphatic alcohols may be used in the esterification. The molar ratios of the aliphatic alcohols may be from 25:75 to 75:25, from 40:60 to 60:40, or about 50:50. Examples of suitable aliphatic alcohol whose mixtures form amorphous compounds when reacted with tartaric acid include cyclohexanol and substituted cyclohexanol (e.g., 2-, 3-, or 4-tert-butyl-cyclohexanol). In embodiments, two or more molar equivalents of alcohol may be used in the reaction to produce the di-esters of tartaric acid. If one molar equivalent of alcohol is used, the result is mostly mono-esters.

Other suitable amorphous components include those disclosed in U.S. patent application Ser. No. 13/095,795 to Morimitsu et al., which is hereby incorporated by reference in its entirety. The amorphous materials may comprise a compound having the following structure:

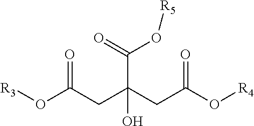

R₃, R₄ and R₅ are independently an alkyl group, wherein the alkyl can be straight, branched or cyclic, saturated or unsaturated, substituted or unsubstituted, having from about 1 to about 16 carbon atoms, and mixtures thereof. In particular, tri-DL-menthyl citrate (TMC) is a desirable amorphous candidate which affords suitable thermal and rheological properties as well imparts robustness to the print images.

These amorphous materials are synthesized by an esterification reaction of citric acid. In particular, citric acid was reacted with a variety of alcohols to make tri-esters according to the synthesis scheme disclosed therein. In embodiments, the phase change ink composition is obtained by using amorphous compounds synthesized from citric acid and at least one alcohol in an esterification reaction.

In embodiments, the amorphous compounds are formulated with a crystalline compound to form a solid ink composition. The ink compositions show good rheological profiles. Print samples created by the solid ink composition on coated paper by K-proof exhibit excellent robustness. Furthermore, using tartaric acid as an ester base has additional advantages of being low cost, and being obtained from a potential bio-derived source.

In embodiments, the solid ink composition is obtained by using novel amorphous compounds synthesized from tartaric acid and at least one alcohol in an esterification reaction. The solid ink composition comprises the amorphous compound in combination with a crystalline compound and a colorant. The present embodiments comprise a balance of amorphous and crystalline compounds to realize a sharp phase transition from liquid to solid and facilitate hard and robust printed images, while maintaining a desired level of viscosity. Prints made with this ink demonstrated advantages over commercially available inks, such as for example, better robustness against scratch. Thus, the present esters of tartaric acid, which provide amorphous compounds for the solid inks, have been discovered to produce robust inks having desirable rheological profiles and that meet the many requirements for inkjet printing.

In embodiments, the amorphous material is present an amount of from about 5 percent to about 40 percent by weight, or from about 5 percent to about 35 percent by weight, or from about 10 percent to about 30 percent by weight of the total weight of the ink composition.

The crystalline materials show sharp crystallization, relatively low viscosity (≦12 centipoise (cps), or from about 0.5 to about 20 cps, or from about 1 to about 15 cps) at a temperature of about 140° C., but very high viscosity (>10⁶ cps) at room temperature. These materials have a melting temperature (Tₘₑₗₜ) of less than 150° C., or from about 65 to about 150° C., or from about 66 to about 145° C., and a crystallization temperature (T_{crys}) of greater than 60° C., or from about 60 to about 140° C., or from about 65 to about 120° C. The ΔT between Tₘₑₗₜ and T_{crys} is less than about 55° C.

The crystalline component may comprise amide, aromatic ester, ester of an aliphatic linear diacid, urethanes, sulfones, or mixtures thereof.

Suitable crystalline components include those disclosed in U.S. patent application Ser. No. ______ to Morimitsu et al. (Attorney Docket No. 20110665-397243), entitled “Phase Change Ink Comprising Crystalline Amides,” which is hereby incorporated by reference in its entirety. These crystalline materials comprise the following structure:

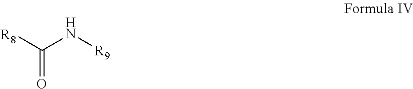

wherein R₈ and R₉ can be the same or different, each R₈ and R₉ is independently selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms, from about 1 to about 20 carbon atoms, or from about 1 to about 10 carbon atoms, (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms, from about 7 to about 20 carbon atoms, or from about 7 to about 12 carbon atoms; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to about 40 carbon atoms, from about 6 to about 20 carbon atoms, or from about 6 to about 10 carbon atoms.

Suitable crystalline components include those disclosed in U.S. patent application Ser. No. ______ to Morimitsu et al. (Attorney Docket No. 20110362-396157), entitled “Phase Change Ink Compositions Comprising Aromatic Ethers,” which is hereby incorporated by reference in its entirety. These crystalline materials comprise the following structure:

R₁₀—O—[(CH₂)₂O]ₚ—R₁₁ Formula V

wherein R₁₀ and R₁₁ can be the same or different, and wherein each R₁₀ and R₁₁ is independently selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms, from about 1 to about 20 carbon atoms, or from about 1 to about 10 carbon atoms; (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms, from about 7 to about 20 carbon atoms, or from about 7 to about 12 carbon atoms; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to about 40 carbon atoms, or about 6 to about 20 carbon atoms, or from about 6 to about 10 carbon atoms, although the numbers can be outside of these ranges, and mixtures thereof, provided that at least one of R₁₀ and R₁₁ is an aromatic group; and p is 0 or 1.

Non-limited examples of crystalline aromatic ether include

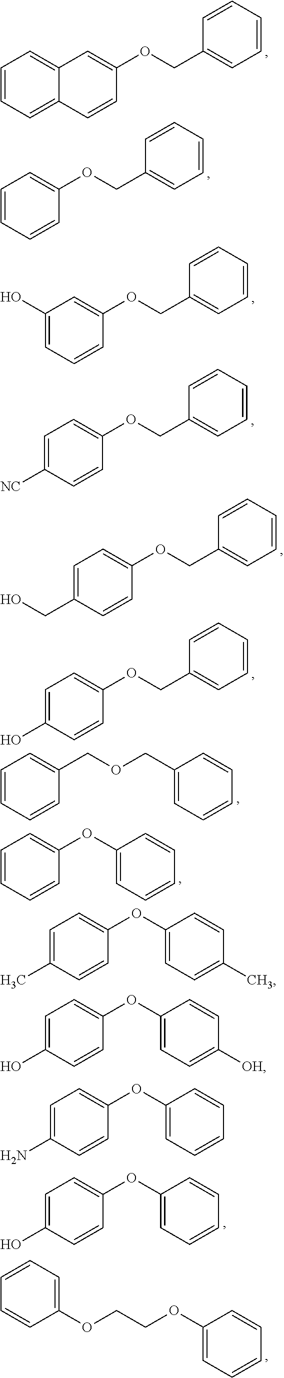

and mixtures thereof.

Suitable crystalline components include those disclosed in U.S. patent application Ser. No. ______ to Chopra et al. (Attorney Docket No. 20101094-390676), entitled “Phase Change Inks and Methods of Making the Same” which is hereby incorporated by reference in its entirety. These crystalline materials comprise an ester of an aliphatic linear diacid having the following structure:

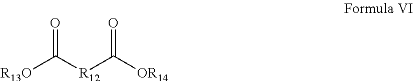

wherein R₁₂ may be substituted or unsubstituted alkyl chain and is selected from the group consisting of —(CH₂)₁— to —(CH₂)₁₂—, and wherein R₁₃ and R₁₄, each independently of the other, is selected from the group consisting of a substituted or unsubstituted aromatic or heteroaromatic group, substituents including alkyl groups, wherein the alkyl portion can be straight, branched or cyclic.

Suitable crystalline components include those disclosed in U.S. patent application Ser. No. ______ to Chopra et al. (Attorney Docket No. 20110356-396152), entitled “Phase Change Ink Compositions Comprising Diurethanes and Derivatives Thereof,” which is hereby incorporated by reference in its entirety. These crystalline materials comprise diurethanes having the following structure:

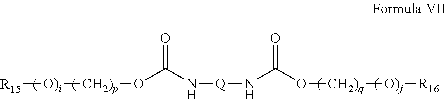

wherein Q is alkanediyl; each R₁₅ and R₁₆ is independently phenyl or cyclohexyl optionally substituted with one or more alkyl; i is 0 or 1; j is 0 or 1; p is 1 to 4; q is 1 to 4. In certain of such embodiments, each R₁₅ and R₁₆ is independently phenyl or cyclohexyl optionally substituted with one or more methyl or ethyl. In certain of such embodiments, R₁₅ and R₁₆ is phenyl. In certain embodiments, Q is —(CH₂)ₙ— and n is 4 to 8. In certain of such embodiments, n is 6. In certain embodiments, each R₁₅ and R₁₆, is independently selected from benzyl, 2-phenylethyl, 2-phenoxyethyl, C₆H₅(CH₂)₄—, cyclohexyl, 2-methylcyclohexyl, 3-phenylpropanyl, 3-methylcyclohexyl, 4-methylcyclohexyl, cyclohexylmethyl, 2-methylcyclohexylmethyl, 3-methylcyclohexylmethyl, 4-methylcyclohexylmethyl, and 4-ethylcyclohexanyl.

Suitable crystalline components include those disclosed in U.S. patent application Ser. No. ______ to Morimitsu et al. (Attorney Docket No. 20110561-396152), entitled “Phase change ink Compositions Comprising Crystalline Sulfone Compounds and Derivatives Thereof” which is hereby incorporated by reference in its entirety. These crystalline component being a sulfone compound having the following structure:

R₁₇—SO₂—R₁₈ Formula VIII

wherein R₁₇ and R₁₈ can be the same or different, and wherein R₁₇ and R₁₈ each, independently of the other is selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms, from about 1 to about 20 carbon atoms, or from about 1 to about 10 carbon atoms, although the numbers can be outside of these ranges, (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms, from about 7 to about 20 carbon atoms, or from about 7 to about 12 carbon atoms, although the numbers can be outside of these ranges; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to from about 40 carbon atoms, from about 6 to about 20 carbon atoms, or about 6 to about 10 carbon atoms, although the numbers can be outside of these ranges, and mixtures thereof.

In certain embodiments, each R₁₇ and R₁₈ is independently alkyl, or aryl, optionally substituted with one or more halo, amino, hydroxy, or cyano groups and combinations thereof, or R₁₇ and R₁₈ taken together with the S atom to which they are attached form a heterocyclic ring. In certain of such embodiments, each R₁₇ and R₁₈ is independently an optionally substituted alkyl, such as, methyl, ethyl, isopropyl, n-butyl, or t-butyl. In certain of such embodiments, each R₆ and R₇ is independently an optionally substituted aryl, such as, phenyl, or benzyl. In certain embodiments, each R₁₇ and R₁₈ is independently substituted with one or more amino, chloro, fluoro, hydroxy, cyano or combinations thereof. Substitution on the aryl groups may be made in the ortho, meta or para position of the phenyl groups and combinations thereof. In certain embodiments, each R₁₇ and R₁₈ is independently 2-hydroxyethyl, or cyanomethyl.

In certain embodiments, the crystalline component may include diphenyl sulfone, dimethyl sulfone, bis(4-hydroxyphenyl) sulfone, bis(4-aminophenyl) sulfone, bis(3-aminophenyl) sulfone, bis(4-chlorophenyl) sulfone, bis(4-fluorophenyl) sulfone, 2-hydroxyphenyl-4-hydroxyphenyl sulfone, phenyl-4-chlorophenyl sulfone, phenyl-2-aminophenyl sulfone, bis(3-amino-4-hydroxyphenyl) sulfone, dibenzyl sulfone, methylethyl sulfone, diethyl sulfone, methylisopropyl sulfone, ethylisopropyl sulfone, di-n-butyl sulfone, divinyl sulfone, methyl-2-hydroxymethyl sulfone, methylchloromethyl sulfone, sulfolane, 3-sulfolene, and mixtures thereof.

In certain embodiments, the phase change ink may comprise a crystallization accelerating additive such as an organic pigment, an inorganic nucleating additive or a fatty acid.

Organic Pigments

In some embodiments, suitable crystallization accelerators include organic pigments. Suitable organic pigments are disclosed in U.S. patent application Ser. No. ______ (not yet assigned) entitled “Phase Change Inks Comprising Organic Pigments” to Jennifer Belelie et al., electronically filed on the same day herewith (Attorney Docket No. 20110418-399388). Suitable organic pigments include but are not limited to include Carbon Black, Pigment Blue 15, Pigment Blue 15:1, Pigment Blue 15:2, Pigment Blue 15:3, Pigment Blue 15:4, Pigment Blue 15:6, Pigment Blue 1, Pigment Blue 10, Pigment Blue 14, Pigment Blue 60, Pigment Blue 61, Pigment Yellow 1, Pigment Yellow 3, Pigment Yellow 12, Pigment Yellow 13, Pigment Yellow 14, Pigment Yellow 17, Pigment Yellow 24, Pigment Yellow 55, Pigment Yellow 62, Pigment Yellow 63, Pigment Yellow 65, Pigment Yellow 73, Pigment Yellow 74, Pigment Yellow 81, Pigment Yellow 83, Pigment Yellow 93, Pigment Yellow 95, Pigment Yellow 97, Pigment Yellow 110, Pigment Yellow 111, Pigment Yellow 123, Pigment Yellow 126, Pigment Yellow 127, Pigment Yellow 139, Pigment Yellow 147, Pigment Yellow 150, Pigment Yellow 151, Pigment Yellow 154, Pigment Yellow 155, Pigment Yellow 168, Pigment Yellow 170, Pigment Yellow 174, Pigment Yellow 175, Pigment Yellow 176, Pigment Yellow 179, Pigment Yellow 180, Pigment Yellow 183, Pigment Yellow 185, Pigment Yellow 188, Pigment Yellow 191, Pigment Yellow 194, Pigment Yellow 214, Pigment Red 2, Pigment Red 3, Pigment Red 4, Pigment Red 5, Pigment Red 8, Pigment Red 9, Pigment Red 12, Pigment Red 13, Pigment Red 21, Pigment Red 22, Pigment Red 23, Pigment Red 31, Pigment Red 32, Pigment Red 48:1, Pigment Red 48:2, Pigment Red 48:3, Pigment Red 48:4, Pigment Red 49:1, Pigment Red 49:2, Pigment Red 52:1, Pigment Red 52:2, Pigment Red 53:1, Pigment Red 53:3, Pigment Red 57:1, Pigment Red 63:1, Pigment Red 81, Pigment Red 112, Pigment Red 122, Pigment Red 123, Pigment Red 144, Pigment Red 146, Pigment Red 149, Pigment Red 166, Pigment Red 169, Pigment Red 170, Pigment Red 171, Pigment Red 175, Pigment Red 176, Pigment Red 177, Pigment Red 178, Pigment Red 179, Pigment Red 184, Pigment Red 185, Pigment Red 188, Pigment Red 189, Pigment Red 202, Pigment Red 208, Pigment Red 210, Pigment Red 224. Pigment Red 242, Pigment Red 245, Pigment Red 254, Pigment Red 266, Pigment Red 268, Pigment Red 269, Pigment Orange 5, Pigment Orange 13, Pigment Orange 16, Pigment Orange 34, Pigment Orange 36, Pigment Orange 63, Pigment Violet 1, Pigment Violet 2, Pigment Violet 3, Pigment Violet 19, Pigment Violet 23, Pigment Violet 27, Pigment Green 7, Pigment Green 36, all listed in the Color Index publication by the Society of Dyers and Colourists and the American Association of Textile Chemists and Colorists

Specific examples of suitable commercially available organic pigments include, but are not limited to, PALIOGEN Violet 5100 (BASF); PALIOGEN Violet 5890 (BASF); HELIOGEN Green L8730 (BASF); LITHOL Scarlet D3700 (BASF); SUNFAST Blue 15:4 (Sun Chemical); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (BASF); PALIOGEN Red 3871K (BASF); SUNFAST Blue 15:3 (Sun Chemical); PALIOGEN Red 3340 (BASF); SUNFAST Carbazole Violet 23 (Sun Chemical); LITHOL Fast Scarlet L4300 (BASF); SUNBRITE Yellow 17 (Sun Chemical); HELIOGEN Blue L6900, L7020 (BASF); SUNBRITE Yellow 74 (Sun Chemical); SPECTRA PAC C Orange 16 (Sun Chemical); HELIOGEN Blue K6902, K6910 (BASF); SUNFAST Magenta 122 (Sun Chemical); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (BASF); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow DI 355, DI 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT); PALIOGEN Black L0084 (BASF); Pigment Black K801 (BASF); and carbon blacks such as REGAL 330™ (Cabot), Carbon Black 5250, Carbon Black 5750 (Columbia Chemical), mixtures thereof and the like. In one embodiment, the ink may contain one organic pigment. In another embodiment, the ink may contain a mixture of at least two different organic pigments.

In specific embodiments, the pigment is present in the ink composition in an amount of at least from about 0.1 percent to about 50 percent by weight, or at least from about 0.5 percent to about 20 percent by weight, from about 0.5 percent to about 10 percent, from about 1 percent to about 5 percent by weight of the total weight of the ink composition.

Typically the organic pigment particle suitable for use in according to the present disclosure have an average particle size of from 10 nm to 400 nm, more specifically a particle size of from 50 nm to 300 nm, or from 80 nm to 250 nm.

Inorganic Pigments

In some embodiments, suitable crystallization accelerators include inorganic nucleating nanoparticle materials. Fast crystallizing crystalline-amorphous inks comprising inorganic pigment materials as crystallization accelerators are disclosed in U.S. patent application Ser. No. ______ (not yet assigned) entitled “Phase Change Inks Comprising Inorganic Nucleating Agents” to Daryl W. Vanbesien et al., electronically filed on the same day herewith (Attorney Docket No. 20111206-400896). The inorganic nucleating agent is selected from a group consisting of silica, silica dioxide, alumina, zinc oxide, inorganic oxides, talc, barium, calcium, sodium, lithium, aluminum, and mixtures thereof.

In certain embodiments, inorganic nucleating agents are nanoparticles. Inorganic nucleating agent particle size typically ranges from 2 nanometers (nm) to about 300 nm. In one embodiment, the ink composition comprises inorganic nucleating agent particles having a particle size of about 10 nm to about 100 nm.

Typically, the inorganic nucleating agent is present in amounts from about 0.1 to about 10 weight percent, from about 0.5 to about 5 weight percent, or from about 1 to about 3 weight percent based on the total weight of the ink composition

Fatty Acid

In some embodiments, the crystallization accelerator is a fatty acid. Such fast crystallizing crystalline-amorphous compositions containing a fatty organic acid are disclosed in U.S. patent application Ser. No. ______ (not yet assigned) entitled “Phase Change Inks Comprising Fatty Acids” to Gabriel Iftime et al., electronically filed on the same day herewith (Attorney Docket No. 20110815-399390).

Specific non-limiting examples of suitable fatty acids include, but are not limited to, palmitic acid (hexadecanoic acid), palmitoleic acid (9-hexadecenoic acid), stearic acid (octadecanoic acid), oleic acid (9-octadecenoic acid), ricinoleic acid (12-hydroxy-9-octadecenoic acid), vaccenic acid (11-octadecenoic acid), linoleic acid (9,12-octadecadienoic acid), alpha-linolenic acid (9,12,15-octadecatrienoic acid), gamma-linolenic acid (6,9,12-octadecatrienoic acid), arachidic acid (eicosanoic acid), gadoleic acid (9-eicosenoic acid), arachidonic acid (5,8,11,14-eicosatetraenoic acid), erucic acid (13-docosenoic acid), and mixtures thereof. In certain embodiments, the fatty acid is stearic acid. In certain embodiments, the fatty acid is behenic acid.

The percentage by weight of the fatty acid in an ink composition of the invention can be between about 0.1% and 25%, between about 1% and 15%, or between about 2% and 10%.

In certain embodiments, a phase change ink composition comprises a blend of a crystalline component and an amorphous component, generally in a weight ratio of from about 60:40 to about 95:5, respectively. In more specific embodiments, the weight ratio of the crystalline to amorphous component is from about 65:35 to about 95:5, or is from about 70:30 to about 90:10, or is from about 70:30 to about 80:20. In other embodiments, the crystalline and amorphous components are blended in a weight ratio of from about 1.5 to about 20 or from about 2.0 to about 10, respectively. Each component imparts specific properties to the phase change inks, and the blend of the components provides inks that exhibit excellent robustness on uncoated and coated substrates. The crystalline component in the ink formulation drives the phase change through rapid crystallization on cooling. The crystalline component also sets up the structure of the final ink film and creates a hard ink by reducing the tackiness of the amorphous component. The amorphous components provide tackiness and impart robustness to the printed ink.

The crystalline and amorphous materials of the present embodiments were found to be miscible with one another and the resulting ink compositions formulated with the crystalline and amorphous materials show good rheological profiles. Image samples created by the phase change ink composition on coated paper by K-proof exhibit excellent robustness. A K-proofer is a common test fixture in a print shop. The present embodiments comprise a balance of amorphous and crystalline materials to realize a sharp phase transition from liquid to solid and facilitate hard and robust printed images, while maintaining a desired level of viscosity. Prints made with this ink demonstrated advantages over commercially available inks, such as for example, better robustness against scratch.

In embodiments, in the molten state, the resulting solid ink has a viscosity of from about 1 to about 22 cps, or from about 4 to about 15 cps, or from about 6 to about 12 cps, at a the jetting temperature. The jetting temperature is typically comprised in a range from about 100° C. to about 140° C. In embodiments, the solid ink has a viscosity of about >10⁶ cps, at room temperature. In embodiments, the solid ink has a Tₘₑₗₜ of from about 65 to about 150° C., or from about 70 to about 140° C., from about 80 to about 135° C. and a T_{crys} of from about 40 to about 140° C., or from about 45 to about 130° C., from about 50 to about 120° C., as determined by DSC at a rate of 10° C./min.

The ink of embodiments may further include conventional additives to take advantage of the known functionality associated with such conventional additives. Such additives may include, for example, at least one antioxidant, defoamer, slip and leveling agents, clarifier, viscosity modifier, adhesive, plasticizer and the like.

The ink may optionally contain antioxidants to protect the images from oxidation and also may protect the ink components from oxidation while existing as a heated melt in the ink reservoir. Examples of suitable antioxidants include N,N′-hexamethylene bis(3,5-di-tert-butyl-4-hydroxy hydrocinnamamide) (IRGANOX 1098, available from BASF), 2,2-bis(4-(2-(3,5-di-tert-butyl-4-hydroxyhydrocinnamoyloxy)) ethoxyphenyl)propane (TOPANOL-205, available from Vertellus), tris(4-tert-butyl-3-hydroxy-2,6-dimethyl benzyl)isocyanurate (Aldrich), 2,2′-ethylidene bis(4,6-di-tert-butylphenyl)fluoro phosphonite (ETHANOX-398, available from Albermarle Corporation), tetrakis(2,4-di-tert-butylphenyl)-4,4′-biphenyl diphosphonite (ALDRICH 46), pentaerythritol tetrastearate (TCI America), tributylammonium hypophosphite (Aldrich), 2,6-di-tert-butyl-4-methoxyphenol (Aldrich), 2,4-di-tert-butyl-6-(4-methoxybenzyl)phenol (Aldrich), 4-bromo-2,6-dimethylphenol (Aldrich), 4-bromo-3,5-didimethylphenol (Aldrich), 4-bromo-2-nitrophenol (Aldrich), 4-(diethyl aminomethyl)-2,5-dimethylphenol (Aldrich), 3-dimethylaminophenol (Aldrich), 2-amino-4-tert-amylphenol (Aldrich), 2,6-bis(hydroxymethyl)-p-cresol (Aldrich), 2,2′-methylenediphenol (Aldrich), 5-(diethylamino)-2-nitrosophenol (Aldrich), 2,6-dichloro-4-fluorophenol (Aldrich), 2,6-dibromo fluoro phenol (Aldrich), a-trifluoro-o-cresol (Aldrich), 2-bromo-4-fluorophenol (Aldrich), 4-fluorophenol (Aldrich), 4-chlorophenyl-2-chloro-1,1,2-tri-fluoroethyl sulfone (Aldrich), 3,4-difluoro phenylacetic acid (Adrich), 3-fluorophenylacetic acid (Aldrich), 3,5-difluoro phenylacetic acid (Aldrich), 2-fluorophenylacetic acid (Aldrich), 2,5-bis (trifluoromethyl) benzoic acid (Aldrich), ethyl-2-(4-(4-(trifluoromethyl)phenoxy)phenoxy)propionate (Aldrich), tetrakis (2,4-di-tert-butyl phenyl)-4,4′-biphenyl diphosphonite (Aldrich), 4-tert-amyl phenol (Aldrich), 3-(2H-benzotriazol-2-yl)-4-hydroxy phenethylalcohol (Aldrich), NAUGARD 76, NAUGARD 445, NAUGARD 512, AND NAUGARD 524 (manufactured by Chemtura Corporation), and the like, as well as mixtures thereof. The antioxidant, when present, may be present in the ink in any desired or effective amount, such as from about 0.25 percent to about 10 percent by weight of the ink or from about 1 percent to about 5 percent by weight of the ink.

In embodiments, the phase change ink compositions described herein may also include a colorant. Any desired or effective colorant can be employed in the phase change ink compositions, including dyes, pigments, mixtures thereof, and the like, provided that the colorant can be dissolved or dispersed in the ink carrier. Any dye or pigment may be chosen, provided that it is capable of being dispersed or dissolved in the ink carrier and is compatible with the other ink components. The phase change carrier compositions can be used in combination with conventional phase change ink colorant materials, such as Color Index (C.I.) Solvent Dyes, Disperse Dyes, modified Acid and Direct Dyes, Basic Dyes, Sulphur Dyes, Vat Dyes, and the like. Examples of suitable dyes include Neozapon Red 492 (BASF); Orasol Red G (Pylam Products); Direct Brilliant Pink B (Oriental Giant Dyes); Direct Red 3BL (Classic Dyestuffs); Supranol Brilliant Red 3BW (Bayer AG); Lemon Yellow 6G (United Chemie); Light Fast Yellow 3G (Shaanxi); Aizen Spilon Yellow C-GNH (Hodogaya Chemical); Bemachrome Yellow GD Sub (Classic Dyestuffs); Cartasol Brilliant Yellow 4GF (Clariant); Cibanone Yellow 2G (Classic Dyestuffs); Orasol Black RLI (BASF); Orasol Black CN (Pylam Products); Savinyl Black RLSN(Clariant); Pyrazol Black BG (Clariant); Morfast Black 101 (Rohm & Haas); Diaazol Black RN (ICI); Thermoplast Blue 670 (BASF); Orasol Blue GN (Pylam Products); Savinyl Blue GLS (Clariant); Luxol Fast Blue MBSN (Pylam Products); Sevron Blue 5GMF (Classic Dyestuffs); Basacid Blue 750 (BASF); Keyplast Blue (Keystone Aniline Corporation); Neozapon Black X51 (BASF); Classic Solvent Black 7 (Classic Dyestuffs); Sudan Blue 670 (C.I. 61554) (BASF); Sudan Yellow 146 (C.I. 12700) (BASF); Sudan Red 462 (C.I. 26050) (BASF); C.I. Disperse Yellow 238; Neptune Red Base NB543 (BASF, C.I. Solvent Red 49); Neopen Blue FF-4012 (BASF); Lampronol Black BR(C.I. Solvent Black 35) (ICI); Morton Morplas Magenta 36 (C.I. Solvent Red 172); metal phthalocyanine colorants such as those disclosed in U.S. Pat. No. 6,221,137, the disclosure of which is totally incorporated herein by reference, and the like. Polymeric dyes can also be used, such as those disclosed in, for example, U.S. Pat. No. 5,621,022 and U.S. Pat. No. 5,231,135, the disclosures of each of which are herein entirely incorporated herein by reference, and commercially available from, for example, Milliken & Company as Milliken Ink Yellow 869, Milliken Ink Blue 92, Milliken Ink Red 357, Milliken Ink Yellow 1800, Milliken Ink Black 8915-67, uncut Reactint Orange X-38, uncut Reactint Blue X-17, Solvent Yellow 162, Acid Red 52, Solvent Blue 44, and uncut Reactint Violet X-80.

Pigments are also suitable colorants for the phase change inks. Examples of suitable pigments include PALIOGEN Violet 5100 (BASF); PALIOGEN Violet 5890 (BASF); HELIOGEN Green L8730 (BASF); LITHOL Scarlet D3700 (BASF); SUNFAST Blue 15:4 (Sun Chemical); Hostaperm Blue B2G-D (Clariant); Hostaperm Blue B4G (Clariant); Permanent Red P-F7RK; Hostaperm Violet BL (Clariant); LITHOL Scarlet 4440 (BASF); Bon Red C (Dominion Color Company); ORACET Pink RF (BASF); PALIOGEN Red 3871K (BASF); SUNFAST Blue 15:3 (Sun Chemical); PALIOGEN Red 3340 (BASF); SUNFAST Carbazole Violet 23 (Sun Chemical); LITHOL Fast Scarlet L4300 (BASF); SUNBRITE Yellow 17 (Sun Chemical); HELIOGEN Blue L6900, L7020 (BASF); SUNBRITE Yellow 74 (Sun Chemical); SPECTRA PAC C Orange 16 (Sun Chemical); HELIOGEN Blue K6902, K6910 (BASF); SUNFAST Magenta 122 (Sun Chemical); HELIOGEN Blue D6840, D7080 (BASF); Sudan Blue OS (BASF); NEOPEN Blue FF4012 (BASF); PV Fast Blue B2GO1 (Clariant); IRGALITE Blue GLO (BASF); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991K (BASF); PALIOTOL Yellow 1840 (BASF); NOVOPERM Yellow FGL (Clariant); Ink Jet Yellow 4G VP2532 (Clariant); Toner Yellow HG (Clariant); Lumogen Yellow D0790 (BASF); Suco-Yellow L1250 (BASF); Suco-Yellow D1355 (BASF); Suco Fast Yellow D1355, D1351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT); PALIOGEN Black L0084 (BASF); Pigment Black K801 (BASF); and carbon blacks such as REGAL 330™ (Cabot), Nipex 150 (Evonik) Carbon Black 5250 and Carbon Black 5750 (Columbia Chemical), and the like, as well as mixtures thereof.

Pigment dispersions in the ink base may be stabilized by synergists and dispersants. Generally, suitable pigments may be organic materials or inorganic.

Also suitable are the colorants disclosed in U.S. Pat. No. 6,472,523, U.S. Pat. No. 6,726,755, U.S. Pat. No. 6,476,219, U.S. Pat. No. 6,576,747, U.S. Pat. No. 6,713,614, U.S. Pat. No. 6,663,703, U.S. Pat. No. 6,755,902, U.S. Pat. No. 6,590,082, U.S. Pat. No. 6,696,552, U.S. Pat. No. 6,576,748, U.S. Pat. No. 6,646,111, U.S. Pat. No. 6,673,139, U.S. Pat. No. 6,958,406, U.S. Pat. No. 6,821,327, U.S. Pat. No. 7,053,227, U.S. Pat. No. 7,381,831 and U.S. Pat. No. 7,427,323, the disclosures of each of which are incorporated herein by reference in their entirety.

In embodiments, solvent dyes are employed. An example of a solvent dye suitable for use herein may include spirit soluble dyes because of their compatibility with the ink carriers disclosed herein. Examples of suitable spirit solvent dyes include Neozapon Red 492 (BASF); Orasol Red G (Pylam Products); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow 5RA EX (Classic Dyestuffs); Orasol Black RLI (BASF); Savinyl Black RLS (Clariant); Morfast Black 101 (Rohm and Haas); Orasol Blue GN (Pylam Products); Thermoplast Blue 670 (BASF); Savinyl Blue GLS (Sandoz); Luxol Fast Blue MBSN (Pylam); Sevron Blue 5GMF (Classic Dyestuffs); Basacid Blue 750 (BASF); Keyplast Blue E (Keystone Aniline Corporation); Neozapon Black X51 (C.I. Solvent Black, C.I. 12195) (BASF); Sudan Blue 670 (C.I. 61554) (BASF); Sudan Yellow 146 (C.I. 12700) (BASF); Sudan Red 462 (C.I. 260501) (BASF), mixtures thereof and the like.

The colorant may be present in the phase change ink in any desired or effective amount to obtain the desired color or hue such as, for example, at least from about 0.1 percent by weight of the ink to about 50 percent by weight of the ink, at least from about 0.2 percent by weight of the ink to about 20 percent by weight of the ink, and at least from about 0.5 percent by weight of the ink to about 10 percent by weight of the ink.

In embodiments, in the molten state, the ink carriers for the phase change inks may have a viscosity of from about 1 to about 22 cps, or from about 4 to about 15 cps, or from about 6 to about 12 cps, at a the jetting temperature. The jetting temperature is typically comprised in a range from about 100° C. to about 140° C. In embodiments, the solid ink has a viscosity of about >10⁶ cps, at room temperature. In embodiments, the solid ink has a Tₘₑₗₜ of from about 65 to about 140° C., or from about 70 to about 140° C., from about 80 to about 135° C. and a T_{crys} of from about 40 to about 140° C., or from about 45 to about 130° C., from about 50 to about 120° C., as determined by DSC at a rate of 10° C./min.

The ink compositions can be prepared by any desired or suitable method. For example, each of the components of the ink carrier can be mixed together, followed by heating, the mixture to at least its melting point, for example from about 60° C. to about 150° C., 80° C. to about 145° C. and 85° C. to about 140° C. The colorant may be added before the ink ingredients have been heated or after the ink ingredients have been heated. When pigments are the selected colorants, the molten mixture may be subjected to grinding in an attritor or ball mill apparatus or other high energy mixing equipment to affect dispersion of the pigment in the ink carrier. The heated mixture is then stirred for about 5 seconds to about 30 minutes or more, to obtain a substantially homogeneous, uniform melt, followed by cooling the ink to ambient temperature (typically from about 20° C. to about 25° C.). The inks are solid at ambient temperature. In a specific embodiment, during the formation process, the inks in their molten state are poured into molds and then allowed to cool and solidify to form ink sticks. Suitable ink preparation techniques are disclosed in U.S. Pat. No. 7,186,762, the disclosure of which is incorporated herein by reference in its entirety.

The inks can be employed in apparatus for direct printing ink jet processes and in indirect (offset) printing ink jet applications. Another embodiment disclosed herein is directed to a process which comprises incorporating an ink as disclosed herein into an ink jet printing apparatus, melting the ink, and causing droplets of the melted ink to be ejected in an imagewise pattern onto a recording substrate. A direct printing process is also disclosed in, for example, U.S. Pat. No. 5,195,430, the disclosure of which is totally incorporated herein by reference. Yet another embodiment disclosed herein is directed to a process which comprises incorporating an ink as disclosed herein into an ink jet printing apparatus, melting the ink, causing droplets of the melted ink to be ejected in an imagewise pattern onto an intermediate transfer member, and transferring the ink in the imagewise pattern from the intermediate transfer member to a final recording substrate. In a specific embodiment, the intermediate transfer member is heated to a temperature above that of the final recording sheet and below that of the melted ink in the printing apparatus. In another specific embodiment, both the intermediate transfer member and the final recording sheet are heated; in this embodiment, both the intermediate transfer member and the final recording sheet are heated to a temperature below that of the melted ink in the printing apparatus; in this embodiment, the relative temperatures of the intermediate transfer member and the final recording sheet can be (1) the intermediate transfer member is heated to a temperature above that of the final recording substrate and below that of the melted ink in the printing apparatus; (2) the final recording substrate is heated to a temperature above that of the intermediate transfer member and below that of the melted ink in the printing apparatus; or (3) the intermediate transfer member and the final recording sheet are heated to approximately the same temperature. An offset or indirect printing process is also disclosed in, for example, U.S. Pat. No. 5,389,958, the disclosure of which is totally incorporated herein by reference. In one specific embodiment, the printing apparatus employs a piezoelectric printing process wherein droplets of the ink are caused to be ejected in imagewise pattern by oscillations of piezoelectric vibrating elements. Inks as disclosed herein can also be employed in other hot melt printing processes, such as hot melt acoustic ink jet printing, hot melt thermal ink jet printing, hot melt continuous stream or deflection ink jet printing, and the like. Phase change inks as disclosed herein can also be used in printing processes other than hot melt ink jet printing processes.

In some situations it may be advantageous to provide an ink which can be printed at high speeds. This requires inks which are capable of solidifying very fast once placed onto the paper, in order to prevent offset of the printed image during fast printing process.

Any suitable substrate or recording sheet can be employed, including coated and plain paper. Coated paper includes silica coated papers such as Sharp Company silica coated paper, JuJo paper, HAMMERMILL LASERPRINT paper, and the like, glossy coated papers such as XEROX Digital Color Elite Gloss, Sappi Warren Papers LUSTROGLOSS, specialty papers such as Xerox DURAPAPER, and the like. Plain paper includes such as XEROX 4200 papers, XEROX Image Series papers, Courtland 4024 DP paper, ruled notebook paper, bond paper. Transparency materials, fabrics, textile products, plastics, polymeric films, inorganic recording mediums such as metals and wood, may also be used.

The inks described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

### Example 1

Crystalline-Amorphous Formulations

Ink Preparation

10 g of mixtures of the crystalline and amorphous materials shown in Tables 1 and 2 were prepared by combining the two components at the proportions shown in the tables (wt %) and stirred at 140° C. for 30 minutes to 1 hour. The crystallization rates of the crystalline materials were measured and the results are shown in Tables 1 and 2.

Rate of Crystallization (TROM results)

TABLE 1
TROM of fast crystallizing ink base formulations.

| Sample | Crystalline (%) | | |
|---|---|---|---|
| 1 | 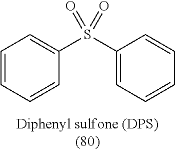 [SMILES: O=S(=O)(c1ccccc1)c1ccccc1] | | |
| 2 | 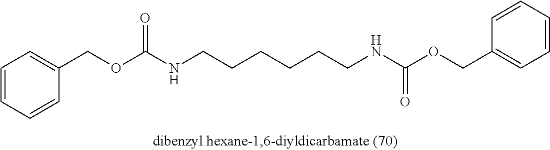 [SMILES: O=C(NCCCCCCNC(=O)OCc1ccccc1)OCc1ccccc1] | | |
| 3 | 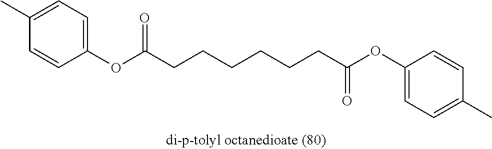 | | |
| 4 | 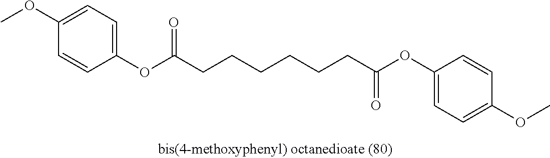 | | |
| | | T test | T total |
| Sample | Amorphous (%) | (° C.) | (s) |
| 1 | 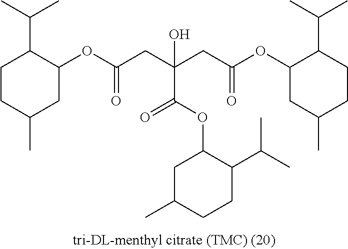 [SMILES: CC1CCC(C(C)C)C(OC(=O)CC(O)(CC(=O)OC2CC(C)CCC2C(C)C)C(=O)OC2CC(C)CCC2C(C)C)C1] | 130 | 4.5 |
| 2 | 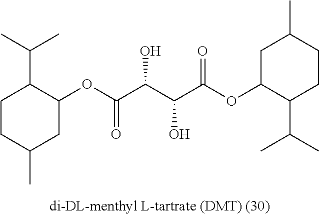 [SMILES: CC1CCC(C(C)C)C(OC(=O)[C@H](O)[C@@H](O)C(=O)OC2CC(C)CCC2C(C)C)C1] | 120 | 12 |
| 3 | 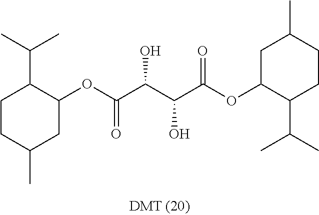 [SMILES: CC1CCC(C(C)C)C(OC(=O)[C@H](O)[C@@H](O)C(=O)OC2CC(C)CCC2C(C)C)C1] | 80; 100; 120; 140 | ~7 |
| 4 | 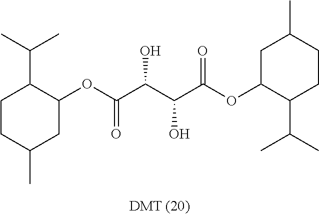 [SMILES: CC1CCC(C(C)C)C(OC(=O)[C@H](O)[C@@H](O)C(=O)OC2CC(C)CCC2C(C)C)C1] | 120; 140 | ~7 |

TABLE 2
TROM of slow crystallizing ink base formulations.

| Sample | Crystalline (%) | | |
|---|---|---|---|
| 5 | 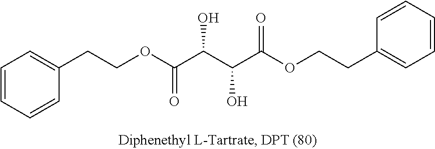 [SMILES: O=C(OCCc1ccccc1)[C@H](O)[C@@H](O)C(=O)OCCc1ccccc1] | | |
| 6 | 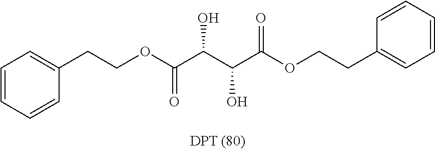 [SMILES: O=C(OCCc1ccccc1)[C@H](O)[C@@H](O)C(=O)OCCc1ccccc1] | | |
| 7 | 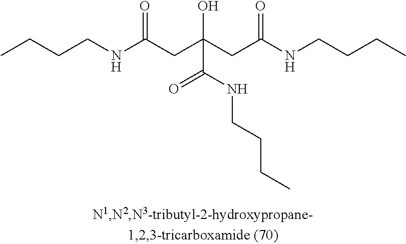 [SMILES: CCCCNC(=O)CC(O)(CC(=O)NCCCC)C(=O)NCCCC] | | |
| | | T test | T total |
| Sample | Amorphous (%) | (° C.) | (s) |
| 5 | 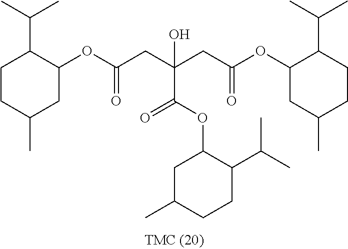 [SMILES: CC1CCC(C(C)C)C(OC(=O)CC(O)(CC(=O)OC2CC(C)CCC2C(C)C)C(=O)OC2CC(C)CCC2C(C)C)C1] | 120 | 175 |
| 6 | 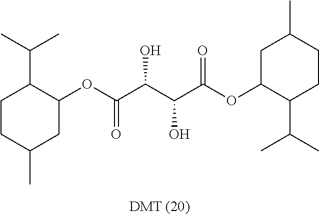 [SMILES: CC1CCC(C(C)C)C(OC(=O)[C@H](O)[C@@H](O)C(=O)OC2CC(C)CCC2C(C)C)C1] | 115 | 20-28 [24] |
| 7 | 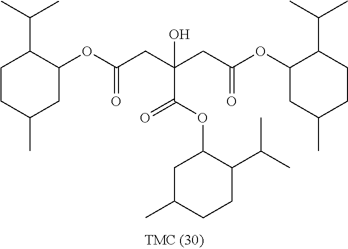 [SMILES: CC1CCC(C(C)C)C(OC(=O)CC(O)(CC(=O)OC2CC(C)CCC2C(C)C)C(=O)OC2CC(C)CCC2C(C)C)C1] | 115 | 310 |

Discussion: Fast Crystallizing Formulations

All of the samples (#1-4) described in Table 1 exhibited fast crystallization time, T total (<15 s) under TROM test conditions. The crystalline components contain aryl or arylalkyl groups and the amorphous components contain only aliphatic groups and the core structures of the crystalline and amorphous components are different.

Discussion: Slow Crystallizing Formulations (Counter Examples)

All samples shown in Table 2 have a slow or very slow T total (>20 s) under TROM test conditions.

As shown in Tables 1 and 2, fast crystallization is not an inherent property of a crystalline-amorphous ink composition. Some crystalline-amorphous formulations demonstrate fast crystallizing property, while some crystalline-amorphous formulations demonstrate slow crystallizing property.

### Example 2

Crystalline-Amorphous Formulations with Crystallization Accelerators:

### Preparation of Ink Samples

DMT was used as the amorphous compound and DPT was used as the crystalline compound in the ink-based formulations. The mixture of DMT and DPT were stirred in the molten state at 140° C. without dye, then cooled down to obtain the ink base samples. The crystalline:amorphous ratio of the ink samples were roughly in the ratio of 80:20 in weight percent. The crystalline and amorphous materials were well-miscible in this mixing ratio.

Ink formulations details are shown in Table 3.

Ink sample 6 contains DPT and DMT without any colorant. Colored inks were prepared by adding dyes or pigments to the ink base (sample 6).

Ink samples 8 contains a dye SB101 and was prepared by mixing 2.475 g of ink sample 6 from above with 0.025 g of SB101 dye at a temperature of 140° C.

Sample 9 contains an organic pigment package (pigment and dispersant), prepared to the specifications shown in the Table 3.

Sample 10 is ink base 6 to which behenic acid was added as a fatty acid crystallization accelerator. Sample 10 was prepared by combining ink base 6 (2.375 g, 95 wt %) and behenic acid (0.125 g, 5 wt %) and stirring at 140° C. for 1 h. The sample was discharged into an aluminum pan and allowed to cool.

Sample 11 is an ink containing an ink base meeting the selection criteria for amorphous and crystalline such as to provide fast crystallizing inks. The amorphous and crystalline components are the same as those from sample 2 in Table 1, but at a higher proportion of crystalline component. The sample contains 2% dye Solvent Blue 10. It is used as baseline 2 ink base for testing acceleration effects of additives in samples 12 and 13

Sample 12 contains the Baseline ink 2 (#11) to which an inorganic nucleating agent (silica nanoparticles) was added to the proportions described in the Table 3.

Sample 13 contains the Baseline ink 2 (#11) to which an organic pigment was added to the proportions described in Table 3. This sample illustrates the synergistic effect on acceleration of the crystallization rate.

TABLE 3
Ink formulations

| | | Ink Sample (wt %) | | | | | | |
|---|---|---|---|---|---|---|---|---|
| Component | Structure | 6 | 8 | 9 | 10 | 11 | 12 | 13 |
| Di-phenethyl L- tartrate (DPT) | 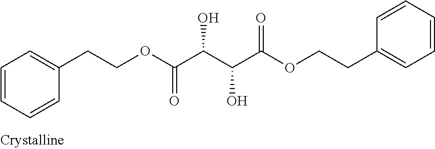 [SMILES: O=C(OCCc1ccccc1)[C@H](O)[C@@H](O)C(=O)OCCc1ccccc1] | 80 | 79.2 | 76.8 | 76.0 | | | |
| Di-DL-menthyl L- tartrate (DMT) | 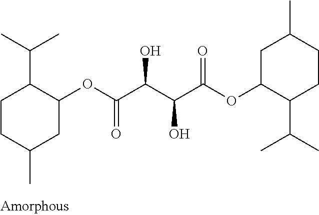 [SMILES: CC1CCC(C(C)C)C(OC(=O)[C@@H](O)[C@H](O)C(=O)OC2CC(C)CCC2C(C)C)C1] | 20 | 19.8 | 19.2 | 19.0 | 19.6 | 18.8 | 18.8 |
| Dibenzyl hexane-1,6- diyldicarbamate | 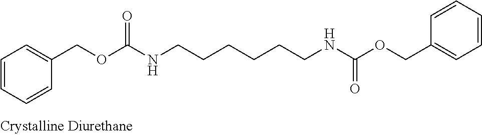 [SMILES: O=C(NCCCCCCNC(=O)OCc1ccccc1)OCc1ccccc1] | | | | | 78.2 | 75.2 | 75.2 |
| SB101-Keyplast | Dye | | 1.0 | | | 2.0 | 2.0 | 2.0 |
| SpectraPAC | Organic Pigment | | | 2.0 | | | | |
| EFKA 4340 | Dispersant | | | 2.0 | | | | |
| Behenic Acid | Fatty Acid | | | | 5.0 | | | |
| Silica Oxide | Inorganic Nucleating | | | | | | 2.0 | |
| | Agent | | | | | | | |
| B4G cyan | Organic Pigment | | | | | | | 2.0 |
| pigment | | | | | | | | |
| Solsperse 32000 | Dispersant | | | | | | 2.0 | 2.0 |

TROM Results (Rate of Crystallization)

Table 4 shows the rate of crystallization times for inks containing crystallization accelerators from Example 2.

TABLE 2
Crystallization Times by TROM

| Ink | Tmelt | T total(s) | Effect on crystallization |
|---|---|---|---|
| 6 | 115 | 24 | baseline 1 |
| 8 | 115 | 107 | deceleration |
| 9 | 125 | 12 | acceleration |
| 10 | 120 | 7 | acceleration |
| 11 | 140 | 7 | baseline ink 2 |
| 12 | 140 | 4 | acceleration |
| 13 | 140 | 5 | acceleration |

Tₘₑₗₜ is the temperature measured in centigrade degrees, at which the ink is molten for the TROM measurement, i.e. at which the TROM cooling process starts. This temperature is typically chosen such as to be identical to the ideal jetting temperature which is comprised in between 10 to 12 cps.

In all cases acceleration of the crystallization rate was observed when the crystallization accelerator was added:

Sample 8: Deceleration of the crystallization by addition of a dye (107 seconds) to a slow crystallizing ink base (Sample 6, 24 seconds), a rather general problem encountered by the inventors.

Sample 9: Demonstrates acceleration of the crystallization of Ink Base from Sample 6 (24 seconds) by addition of an organic pigment package (12 seconds).

Sample 10: Demonstrates acceleration of crystallization of ink base from Sample 6 (24 seconds) by the addition of a fatty acid crystallization accelerator (7 seconds).

Sample 11: Is an example of a fast crystallizing inks made by selecting the crystalline and amorphous components such as to meet the selection criteria for reduced compatibility. Total crystallization time is reduced from 107 seconds (Sample 8) to 7 seconds.

Sample 12. Demonstrates acceleration of the crystallization of the Baseline ink 2 (7 seconds) by addition of an inorganic nucleating agent (silica; 4 seconds).

Sample 13: Illustrates the synergetic effect: Combines two different approaches to fast crystallization: (a) Fast ink base (Baseline ink 2) made according to selection criteria (Sample 11; 7 seconds) with (b) an organic pigment package (Sample 9, 12 seconds) to provide an ink which is faster than any of the two individual inks (5 seconds).

### Example 3

Robustness Demonstration of Fast Crystallizing Ink

The inks #8 to #13 described in Table 3 were subsequently coated using a K-printing proofer (manufactured by RK Print Coat Instrument Ltd., Litlington, Royston, Heris, SG8 0OZ, U.K.) onto Xerox digital Color Elite Gloss, 120 gsm (DCEG) to form robust images that could not be easily removed from the substrate.

When a scratch/gouge finger with a curved tip at an angle of about 15° from vertical, with a weight of 528 g applied, was drawn across the images at a rate of approximately 13 mm/s no ink was visibly removed from the images. The scratch/gouge tip is similar to a lathe round nose cutting bit with radius of curvature of approximately 12 mm.

2.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification.

1. A phase change ink comprising:
an amorphous compound; and
a crystalline compound;
wherein the amorphous compound comprises an ester of citric acid of Formula II 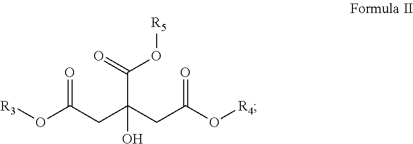
wherein each R₁, R₂, R₃, R₄ and R₅ is independently an alkyl group, wherein the alkyl can be straight, branched or cyclic, saturated or unsaturated, substituted or unsubstituted, having from about 1 to about 16 carbon atoms;
wherein the phase change ink is capable of crystallizing at a total crystallization time of less than 15 seconds.

2. The phase change ink of claim 1, wherein the total crystallization time comprises a time onset of less than 6 seconds.

3. The phase change ink of claim 1 further comprising a colorant.

4. The phase change ink of claim 1, wherein the crystalline compound is present in an amount of from 60 percent to 95 percent by weight of the total weight of the phase change ink.

5. The phase change ink of claim 1, wherein the amorphous compound is present in an amount of from 5 percent to 40 percent by weight of the total weight of the phase change ink.

6. The phase change ink of claim 1, wherein the crystalline/amorphous ratio is from 60:40 to 95:5.

7. The phase change ink of claim 1, wherein the crystalline compound has a viscosity of less than 12 cps at a temperature of 140° C. and a viscosity of greater than 1×10⁶ cps at room temperature.

8. The phase change ink of claim 1, wherein the ink has a viscosity of less than 22 cps at a temperature of 140° C. and a viscosity of greater than 1×10⁶ cps at room temperature.

9. (canceled)

10. The phase change ink of claim 1, wherein the alkyl group is a cycloalkyl optionally substituted with one or more alkyl.

11. (canceled)

12. (canceled)

13. The phase change ink of claim 12, wherein the crystalline compound comprises sulfone having the following formula:
R₁₇—SO₂—R₁₈Formula III
wherein each R₁₇ and R₁₈ independently of the other is selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms; (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms,; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to from about 40 carbon atoms; and mixtures thereof.

14. The phase change ink of claim 12, wherein the crystalline compound comprises amide having the following formula: 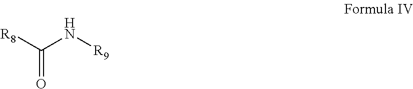
wherein R₈ and R₉ can be the same or different, each R₈ and R₉ is independently selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms; (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to about 40 carbon atoms.

15. The phase change ink of claim 12, wherein the crystalline compound comprises aromatic ether having the following formula:
R₁₀—O—[(CH₂)₂O]ₚ—R₁₁ Formula V
wherein R₁₀ and R₁₁ can be the same or different, and wherein each R₁₀ and R₁₁ is independently selected from the group consisting of (i) an alkyl group, which can be a linear or branched, cyclic or acyclic, substituted or unsubstituted, saturated or unsaturated, alkyl group, and wherein heteroatoms may optionally be present in the alkyl group, in embodiments, having from about 1 to about 40 carbon atoms; (ii) an arylalkyl group, which can be a substituted or unsubstituted arylalkyl group, wherein the alkyl portion of arylalkyl group can be linear or branched, cyclic or acyclic, substituted or unsubstituted, saturated or unsaturated, and wherein heteroatoms may optionally be present in either the aryl portion or the alkyl portion of the arylalkyl group, in embodiments, having from about 4 to about 40 carbon atoms; and (iii) an aromatic group, which can be a substituted or unsubstituted aromatic group, wherein the substituent can be a linear, branched, cyclic or acyclic alkyl group and wherein heteroatoms may optionally be present in the aromatic group, having from about 3 to about 40 carbon atoms; and mixtures thereof, provided that at least one of R₁₀ and R₁₁ is an aromatic group; and p is 0 or 1.

16. The phase change ink from claim 1, wherein the crystalline compound comprises diurethane having the following formula: 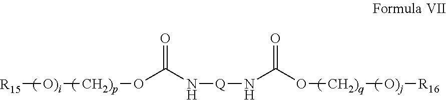
wherein Q is alkanediyl; each R₁₅ and R₁₆ is independently phenyl or cyclohexyl optionally substituted with one or more alkyl; i is 0 or 1; j is 0 or 1; p is 1 to 4; and q is 1 to 4.

17. The phase change ink from claim 12, wherein the crystalline component comprises an ester of an aliphatic linear diacid having the following formula: 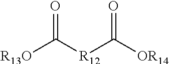
wherein R₁₂ may be substituted or unsubstituted alkyl chain and is selected from the group consisting of —(CH₂)₁— to —(CH₂)₁₂—, and wherein R₁₃ and R₁₄, each independently of the other, is selected from the group consisting of a substituted or unsubstituted aromatic or heteroaromatic group, substituents including
alkyl groups, wherein the alkyl portion can be straight, branched or cyclic.

18. The phase change ink of claim 1 further comprising
a crystallization accelerating additive.

19. The phase change ink from claim 18 wherein the crystallization accelerating additive is an organic pigment, an inorganic nucleating additive or an fatty acid.

20. (canceled)

21. The phase change ink of claim 1, wherein one of R₃, R₄ and R₅ is 2-isopropyl-5-methylcyclohexyl, and the other one of R₃, R₄ and R₅ is 2-isopropyl-5-methylcyclohexyl, 4-t-butylcyclohexyl, or cyclohexyl, or one of R₃, R₄ and R₅ is 4-t-butylcyclohexyl, and the other one of R₃, R₄ and R₅ is cyclohexyl.

22. The phase change ink of claim 21, wherein R₃, R₄ and R₅ are each 2-isopropyl-5-methylcyclohexyl.

23. The phase change ink of claim 21, wherein R₃ is 2-isopropyl-5-methylcyclohexyl and R₄ and R₅ are each 4-t-butylcyclohexyl.

24. The phase change ink of claim 21, wherein R₃ is 2-isopropyl-5-methylcyclohexyl and R₄ and R₅ are each cyclohexyl.

25. The phase change ink of claim 21, wherein R₁ is 4-t-butylcyclohexyl and R₄ and R₅ are each cyclohexyl.

26. A phase change ink comprising:
an amorphous compound; and
a crystalline compound;
wherein the amorphous compound comprises an ester of tartaric acid of Formula I 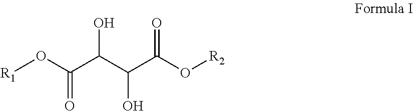
wherein one of R₁ and R₂ is 2-isopropyl-5-methylcyclohexyl, and the other one of R₁ and R₂ is 2-isopropyl-5-methylcyclohexyl, 4-t-butylcyclohexyl, or cyclohexyl, or one of R₁ and R₂ is 4-t-butylcyclohexyl, and the other one of R₁ and R₂ is cyclohexyl;
wherein the crystalline compound comprises diurethane having the following formula: 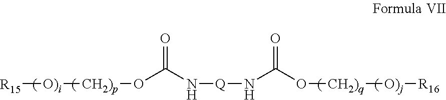
wherein Q is alkanediyl; each R₁₅ and R₁₆ is independently phenyl or cyclohexyl optionally substituted with one or more alkyl; i is 0 or 1; j is 0 or 1; p is 1 to 4; and q is 1 to 4.

27. The phase change ink of claim 26, wherein R₁ and R₂ are each 2-isopropyl-5-methylcyclohexyl.

28. The phase change ink of claim 26, wherein R₁ is 2-isopropyl-5-methylcyclohexyl and R₂ is 4-t-butylcyclohexyl.

29. The phase change ink of claim 26, wherein R₁ is 2-isopropyl-5-methylcyclohexyl and R₂ is cyclohexyl.
